(19) United States
(12) Patent Application Publication
(10) Pub. No.: US 2012/0092440 A1
(43) Pub. Date: Apr. 19, 2012

(54) METHOD AND APPARATUS FOR VIDEO COMMUNICATION

(75) Inventors: Yong Ju CHO, Seoul (KR); Ji Hun CHA, Daejeon-si (KR); Jin Woong KIM, Daejeon-si (KR)

(73) Assignee: Electronics and Telecommunications Research Institute, Daejon (KR)

(21) Appl. No.: 13/275,542

(22) Filed: Oct. 18, 2011

(30) Foreign Application Priority Data
Oct. 19, 2010 (KR) 10-2010-0102154

(51) Int. Cl. H04N 7/14

(52) U.S. Cl. 348/14.07; 348/E07.077

(57) ABSTRACT

A video communication apparatus in which eye contact can be made with an opposite party of a conversation is provided. The video communication apparatus includes: a monitor unit for video communication; and a camera unit for capturing an image of a user, wherein the monitor unit repeats mode switching between a video mode and a transparent mode according to a specific period, and wherein the camera unit is located behind the monitor unit and captures the image of the user by using a screen of the monitor unit. Accordingly, eye contact can be made with the opposite party when users who participate in video communication talk to each other while seeing communication images.

### CROSS-REFERENCE TO RELATED APPLICATIONS

This application claims the benefit of priority of Korean Patent Application No. 10-2010-0102154 filed on Oct. 19, 2010 which are incorporated by reference in their entirety herein.

### BACKGROUND

1. Technical Field

The present invention relates to a video communication technique, and more particularly, to a technique for performing effective video communication with an opposite party of video communication.

2. Related Art

With the growth of Internet protocol television (IPTV) and smart-phone markets, there is an increasing demand on large-volume data transmission services. In addition thereto, even a smart TV service is expected to be commercialized in the near future.

Meanwhile, Internet-based video communication services are widely used in mobile phones using a smart-phone technique or the like. When various large-volume data services such as a smart TV service or the like are commercialized, video communication services can be provided through TV media.

Video communication allows a user to talk to an opposite party while seeing an image of the opposite party. In a current globalized social environment, demands on the video communication are gradually increased. For example, various demands are expected such as conversations with a family member or friend who lives far away, remote business meetings, remote medical advices, etc.

In the video communication, it is important to make users have the same feeling as if they were talking while seeing each other similarly to the case of an actual face-to-face conversation. Eye contact is the most common way of sharing feelings tacitly between two people when they actually meet to make a conversation.

Therefore, eye contact is also important in the video communication. However, it is not easy to make eye contact with the opposite party in actual video communication. This is because a perspective of a camera which captures images of the people who participate in a conversation does not coincide with a perspective of a monitor which outputs their images. That is, since the camera and the monitor have different perspectives, it is difficult to make eye contact between the two people.

FIG. 1 is a schematic view showing the conventional way of video communication.

Referring to FIG. 1, cameras 110 and 150 (e.g., web-cams, etc.) generally used for the video communication may be attached above monitor screens 140 and 180, or may be located at edges of the screens.

In general, the video communication is made between people who participate in a conversation while viewing videos showing faces of their opposite parties. Therefore, perspectives 130 and 170 of the two people do not coincide with perspectives 120 and 160 of the cameras 110 and 150, i.e., perspectives of their opposite parties. In this case, when the users stare the cameras 110 and 150 to send their perspectives to their opposite parties, they cannot see images of their opposite parties, that is, cannot see communication images.

### SUMMARY

The present invention provides a method and apparatus capable of achieving effective video communication.

The present invention also provides a video communication method and apparatus in which eye contact can be made efficiently and naturally with an opposite party of video communication.

The present invention also provides a video communication method and apparatus in which eye contact can be made with an opposite party when people who participate in video communication talk to each other while seeing communication images.

According to an aspect of the present invention, there is provided a video communication apparatus including: a monitor unit for video communication; and a camera unit for capturing an image of a user, wherein the monitor unit repeats mode switching between a video mode and a transparent mode according to a specific period, and wherein the camera unit is located behind the monitor unit and captures the image of the user by using a screen of the monitor unit.

In the aforementioned aspect of the present invention, the apparatus may further include a synchronization unit for synchronizing a mode switching period of the monitor unit and a capturing period of the camera unit. The camera unit may capture the user only when the monitor unit is in the transparent mode.

In addition, the camera unit may be located at a center portion in a back side of the monitor unit.

In addition, the monitor unit may use a screen by splitting the screen, and the camera unit may move in a back side of the monitor unit.

In addition, the camera unit may be located at a center portion in a back side of a screen portion used for video communication among the split screens of the monitor.

In addition, the camera unit may be located behind an eye portion of the opposite party's image displayed on the screen of the monitor.

According to another aspect of the present invention, there is provided a video communication apparatus including: a receiver for receiving an opposite party's image captured according to a specific video period; a monitor unit for displaying the received image according to a display period; and a synchronization unit for synchronizing the video period of the received image and the display period of the monitor unit.

In the aforementioned aspect of the present invention, the apparatus may further include a camera unit for capturing an image of a user from a back side of the monitor unit. The monitor unit may repeat mode switching between a video mode and a transparent mode according to the display period.

In addition, the camera unit may capture the image of the user only when the monitor unit is in the transparent mode.

In addition, the monitor unit may use a screen by splitting the screen.

In addition, the video communication apparatus may further include a camera for capturing an image of a user from a back side of a screen used for video communication among the split screens of the monitor unit.

In addition, the camera unit may capture the image of the user only when the monitor unit is in the transparent mode.

According to another aspect of the present invention, there is provided a video communication method including: outputting received video communication data as a video image of a monitor; capturing an image of a user from a back side of a screen of the monitor; and transmitting the captured user's image to an opposite party of video communication as video communication data, wherein the outputting of the video image and the capturing of the user's image are repetitively performed in parallel, and wherein the monitor periodically repeats a video mode and a transparent mode.

In the aforementioned aspect of the present invention, the capturing of the user's image may be performed only when the monitor is in the transparent mode.

In the aforementioned aspect of the present invention, the video communication method may further include, if the received video communication data is streaming data for transmitting video data according to a specific period, synchronizing a video data period of the streaming data and a mode switching period of the monitor.

In addition, the camera may be located at a center portion in a back side of the monitor.

In addition, the video communication method may further include changing a position and/or an angle of a camera according to perspective movement of the user.

### BRIEF DESCRIPTION OF THE DRAWINGS

FIG. 1 is a schematic view showing the conventional way of video communication.

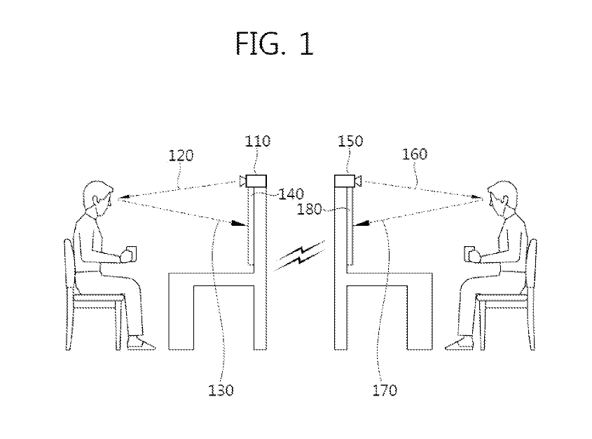

FIG. 2 is a schematic perspective view showing positions of a camera and a monitor in an example of a video communication system according to the present invention.

FIG. 3 is a schematic plan view showing positions of a camera and a monitor in an example of a video communication system according to the present invention.

FIG. 4 is a schematic view showing the concept of an operation for repeating a video mode and a transparent mode by a monitor according to the present invention.

FIG. 5 is a schematic view showing an example of a communication image output according to the present invention.

FIG. 6 is a schematic block diagram showing an example of a video communication apparatus according to the present invention.

FIG. 7 is a schematic flowchart showing an embodiment of a video communication method according to the present invention.

### DESCRIPTION OF EXEMPLARY EMBODIMENTS

Hereinafter, exemplary embodiments of the present invention will be described in detail with reference to the accompanying drawings.

Wherever possible, the same reference numbers will be used throughout the drawings to refer to the same or like parts.

In the following description, well-known functions or constructions are not described in detail since they would obscure the invention in unnecessary detail.

Various methods for matching perspectives of opposite parties of video communication have recently been considered.

One of the methods is a method in which an image of a user who watches a screen is reflected on a translucent mirror and is then input to a camera. In this method, video quality of the video communication is not good since a small quantity of light is concentrated onto the camera by the use of the translucent mirror. Since the video communication system includes not only a monitor and the camera but also a large mirror located between the monitor and the camera, the video communication system increases in size.

It may also consider a method in which a hole is pierced through the monitor or the screen on which an image of the opposite party is output so that the camera captures the image of the opposite party through the hole. In this method, a pupil for the camera appears on the image of the opposite party, and a great quantity of light caused by the screen output is concentrated together with the image of the user, which leads to poor video quality of the video communication.

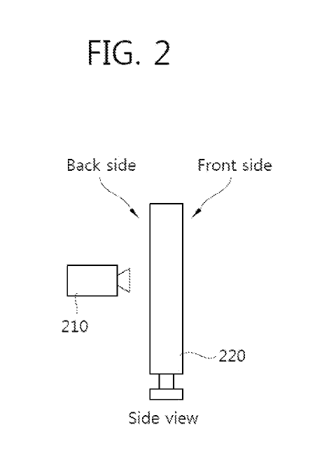

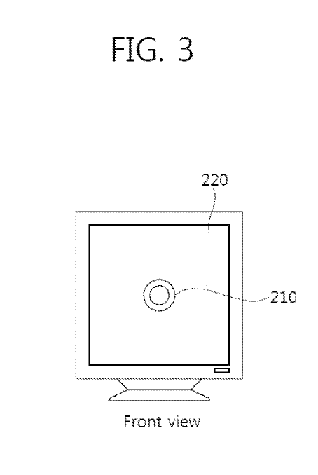

FIG. 2 is a schematic perspective view showing positions of a camera and a monitor in an example of a video communication system according to the present invention. FIG. 3 is a schematic plan view showing positions of a camera and a monitor in an example of a video communication system according to the present invention.

Referring to FIG. 2, a camera 210 for the video communication is located behind a monitor 220 that outputs an image of an opposite party for the video communication.

Referring to FIG. 3, a camera 210 for the video communication is located behind a monitor 220 and faces a front side of the monitor 220. Therefore, the camera 210 can capture an image of a user who uses a video communication service by using the monitor 220 according to a state of the monitor 220.

In the present invention, the monitor 220 repeats mode switching between a video mode and a transparent mode. Herein, the video mode is a state in which a screen of the monitor outputs a communication image of the opposite party. The transparent mode is a state in which the screen of the monitor becomes transparent so that light can be transmitted. The transparent mode can be implemented by using various methods.

The monitor 220 may repeat the mode switching between the video mode and the transparent mode according to a specific period. In addition, the monitor 220 may perform the mode switching between the video mode and the transparent mode according to a predetermined rule, instead of performing the mode switching periodically.

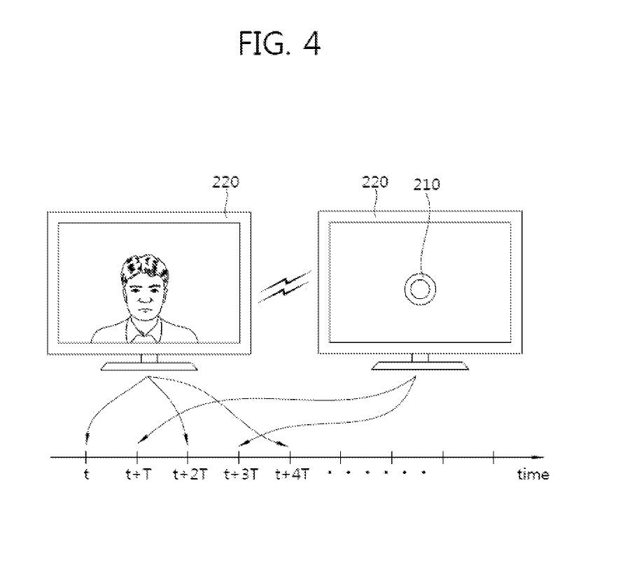

FIG. 4 is a schematic view showing the concept of an operation for repeating a video mode and a transparent mode by a monitor 220 according to the present invention. Referring to FIG. 4, the monitor 220 outputs a communication image of an opposite party in the video mode at a time t. Subsequently, after a time T elapses, the monitor 220 switches to the transparent mode, and captures a communication image of a user by using a camera 210. The switching between the video mode and the transparent mode can be achieved in every period T.

Although it is described in FIG. 4 that the switching between the video mode and the transparent mode is achieved in every period T, the present invention is not limited thereto, and thus temporal distribution of the both modes can be controlled by considering a state of a video communication service such as a state of capturing a video image, a state of outputting the communication image of the opposite party, etc.

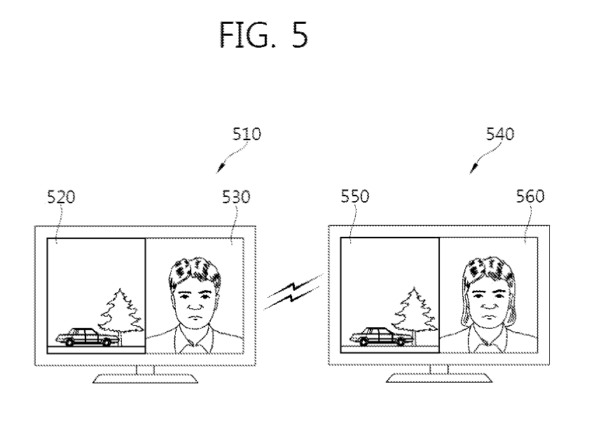

FIG. 5 is a schematic view showing an example of a communication image output according to the present invention.

In the present invention, a user of a video communication service can use a monitor screen of a video communication system by splitting the screen. Referring to FIG. 5, the user may use screens of video communication monitors 510 and 540 by splitting the screens into portions 520 and 550 on which TV screens are output and portions 530 and 560 on which communication images of video communication are output.

In this case, both users may use screens of monitors by splitting the screens. Alternatively, one user may use a screen of a monitor by splitting the screen into two portions and the other user may use a screen of a monitor for only video communication.

Hereinafter, an example of a video communication apparatus according to the present invention will be described in detail with reference to the accompanying drawings.

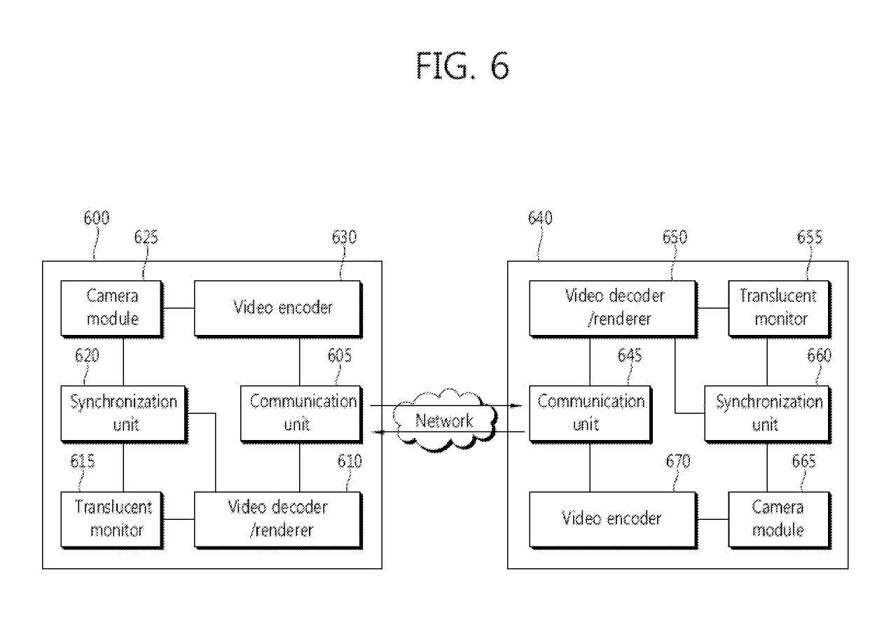

FIG. 6 is a schematic block diagram showing an example of a video communication apparatus according to the present invention. It is assumed herein that two people who participate in video communication use video communication apparatus 600 and 640 according to the present invention.

The video communication apparatus 600 and 640 include communication units 605 and 645, video decoders/renderers 610 and 650, translucent monitors 615 and 655, synchronization units 620 and 660, camera modules 625 and 665, and video encoders 630 and 670.

The communication units 605 and 645 transmit video data, which is output from the video encoders 630 and 670 for the people who participate in the video communication, to the video communication apparatuses of their opposite parties of the video communication. In this case, the video communication data may include voice data. In addition, the video communication data is transmitted through a wired network and/or a wireless network. In addition, the communication units 605 and 645 receive the video communication data transmitted from the video communication apparatuses of the opposite parties of the video communication and deliver the receive data to the video decoders/renderers 610 and 650.

The video decoders/renderers 610 and 650 decode the video communication data delivered from the communication units 605 and 645. In addition, the video decoders/renderers 610 and 650 perform a rendering process on video data of the decoded communication data and output the processed video data.

The video data or video communication data output from video decoders/renderers 610 and 650 is output to the translucent monitors 615 and 655. Herein, the translucent monitor is a monitor capable of performing mode switching between a video mode and a transparent mode as described above.

The synchronization units 620 and 660 may be connected to the video decoders/renderers 610 and 650 and the translucent monitors 615 and 655 to synchronize a mode switching period of the translucent monitors and an output period of video communication data from the video decoders/renderers 610 and 650.

The camera modules 625 and 665 are located behind the translucent monitors 615 and 655, and may capture communication images of the video communication users when the translucent monitors 615 and 655 are in the transparent mode.

The synchronization units 620 and 660 may be connected to the camera modules 625 and 665 to synchronize a capturing period of the cameras to the mode switching period of the translucent monitors 615 and 655. When the camera modules 625 and 665 are synchronized to the translucent monitors 615 and 655 to capture images of the users, unnecessary power consumption can be reduced and video data processing can be performed easily.

For example, if a screen of a monitor is reproduced 30 times per one second, i.e., if the video mode is switched 30 times per one second and the transparent mode is switched 30 times per one second, then when the video mode is an initial state, as described above in FIG. 4, an image of an opposite party is output on the screen at 1/60 seconds, the mode is switched to the transparent mode at 2/60 seconds to capture the image of the user, and the mode is switched back to the video mode at 3/60 seconds to output the image of the opposite party.

Although it is described in FIG. 6 that the camera modules 625 and 665 are connected to the synchronization units 620 and 660 to synchronize the capturing period to the switching period of the translucent monitors 615 and 655, the present invention is not limited thereto. Thus, the camera modules 625 and 665 may persistently perform capturing without being synchronized to the translucent monitors 615 and 655.

In this case, when the translucent monitors 615 and 655 are in the video mode, the communication image of the user is not captured. In this case, data of a duration in which the communication image of the user is not captured may be additionally processed by the video encoders 630 and 670 and be deleted from the video communication data, and upon receiving the data, the video decoders/renderers 610 and 650 of the video communication apparatuses may regulate an output of the corresponding part by synchronizing the outputs of the translucent monitors 615 and 655.

The video encoders 630 and 670 encode video data output from the camera modules 625 and 665 and deliver the encoded data to the communication units 605 and 645.

It has been described that two people participate in the video communication, i.e., that two video communication apparatuses are used. However, the present invention is not limited thereto, and thus can equally apply to a case where two or more people participate in the video communication by using a plurality of video communication apparatuses. In this case, the monitor 220 may split its screen by the number of users participating in the video communication so that images of all users can be seen on one monitor. In this case, the camera 210 may be located behind a portion in which an image of the opposite party who is currently performing video communication is output, so that the two people can make eye contact with each other.

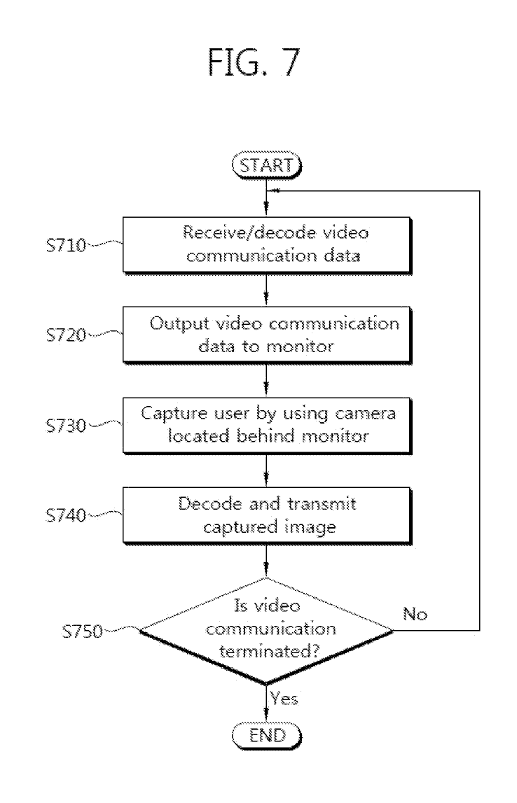

FIG. 7 is a schematic flowchart showing an embodiment of a video communication method according to the present invention.

When video communication starts, a user receives video communication data from an opposite party of video communication and decodes the data (step S710). In this case, the video communication data may be a video stream.

A monitor of a video communication apparatus outputs the video communication data received in every predetermined period to a screen (step S720). A camera of the video communication apparatus captures the user from a back side of the monitor (step S730).

The monitor of the video communication apparatus is a translucent monitor as described above. Therefore, a video mode in which the video communication data is output to the screen and a transparent mode in which the camera located behind the monitor can capture an image of the user are repetitively switched periodically/non-periodically. When the monitor is in the transparent mode, the camera captures the image of the user from the back side of the monitor.

A time at which the camera can capture the image of the user is determined according to a mode switching period of the monitor. Therefore, the video communication data of the user captured by the camera is obtained according to the mode switching period of the monitor. The camera may capture images by being synchronized to the mode switching period of the monitor by means of a synchronization unit of the video communication apparatus as described above. In addition, the camera may capture images irrespective of the mode switching period of the monitor. In this case, a communication image of the user is not included in data obtained when the monitor is in the video mode.

Therefore, the video communication data received from the opposite party is data obtained when the communication image of the opposite party is captured periodically as described above. When the communication image of the opposite party is captured in the video communication apparatus of the opposite party by being synchronized to the mode switching period of the monitor, the monitor unit and the synchronization unit of the video communication apparatus of the user can output video communication data of the opposite party according to the mode switching period of the opposite party. Therefore, a period of the video mode for outputting an image from the monitor of the user, i.e., the mode switching period, may be set to the same value as the mode switching period of the monitor in the video communication apparatus of the opposite party.

Alternatively, the mode switching period may be set to a multiple number of the mode switching period of the monitor in the video communication apparatus of the opposite party according to a communication environment or a specification of the video communication apparatus of the user, or may be set to a specific period according to a usage environment of the user.

When the communication image of the opposite party is captured irrespective of the mode switching period of the monitor in the video communication apparatus of the opposite party, the monitor unit and the synchronization unit in the video communication apparatus of the user are synchronized to the mode switching period of the monitor in the video communication apparatus of the opposite party to output the video communication data of the opposite party. Therefore, video data obtained for the opposite party by means of the camera when the monitor of the opposite party is in the transparent mode is output when the monitor of the user is in the video mode. Video communication data not including the video data obtained for the opposite party when the monitor of the opposite party is in the video mode is output when the monitor of the user is in the transparent mode or is separately processed in the video communication apparatus. In this case, information regarding the mode switching period of the monitor in the video communication apparatus of the opposite party may be transmitted in advance by using a communication unit or may be delivered in advance to the two people who participate in the video communication according to a predetermined rule. In addition, the mode switching period for the monitor in the video communication apparatus may be set to a fixed value according to a specific specification in each video communication apparatus.

An image captured by a camera module is decoded and transmitted to the opposite party (step S740). The user determines whether to terminate the video communication (step S750), and if it is determined to terminate the video communication, the whole procedure is terminated. Otherwise, if it is determined not to terminate the video communication, the video communication data of the opposite party is received again (step S710).

Although the steps of receiving the video data of the opposite party (step S710), outputting the received video data to the monitor (step S720), capturing the image of the user by the camera (step S730), and decoding and transmitting the captured image (step S740) are described herein in a time-series manner, this is for explanation purposes only, and thus the present invention is not limited thereto.

The step S710 and S720 for receiving and outputting the video communication data and the steps S730 and S740 for capturing and transmitting the video communication data may be performed in parallel to each other. Therefore, the step of transmitting the video communication data of the user is performed together with the step of receiving the video communication data of the opposite party. In addition, the step of outputting the video communication data of the opposite party to the monitor and the step of capturing the video communication data of the user by using the camera are alternately performed repetitively according to the mode switching period of the monitor. The step of outputting the video communication data of the opposite party to the monitor may be performed temporally prior to the step of capturing the video communication data of the user by using the camera, or the step of capturing the video communication data of the user by using the camera may be performed temporally prior to the step of outputting the video communication data of the opposite party to the monitor.

According to the present invention, effective video communication such as face-to-face communication can be achieved.

According to the present invention, eye contact can be made efficiently and naturally with an opposite party of video communication.

According to the present invention, eye contact can be made with an opposite party when users who participate in video communication talk to each other while seeing communication images.

The present invention can be implemented with hardware, software, or combination thereof. In hardware implementation, the present invention can be implemented with one of an application specific integrated circuit (ASIC), a digital signal processor (DSP), a programmable logic device (PLD), a field programmable gate array (FPGA), a processor, a controller, a microprocessor, other electronic units, and combination thereof, which are designed to perform the aforementioned functions. In software implementation, the present invention can be implemented with a module for performing the aforementioned functions. Software is storable in a memory unit and executed by the processor. Various means widely known to those skilled in the art can be used as the memory unit or the processor.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A video communication apparatus comprising:
a monitor unit for video communication; and
a camera unit for capturing an image of a user,
wherein the monitor unit repeats mode switching between a video mode and a transparent mode according to a specific period, and
wherein the camera unit is located behind the monitor unit and captures the image of the user by using a screen of the monitor unit.

2. The video communication apparatus of claim 1, further comprising a synchronization unit for synchronizing a mode switching period of the monitor unit and a capturing period of the camera unit, wherein the camera unit captures the user only when the monitor unit is in the transparent mode.

3. The video communication apparatus of claim 1, wherein the camera unit is located at a center portion in a back side of the monitor unit.

4. The video communication apparatus of claim 1,
wherein the monitor unit can use a screen by splitting the screen, and
wherein the camera unit can move in a back side of the monitor unit.

5. The video communication apparatus of claim 4, wherein the camera unit is located at a center portion in a back side of a screen portion used for video communication among the split screens of the monitor.

6. The video communication apparatus of claim 1, wherein the camera unit is located behind an eye portion of the opposite party's image displayed on the screen of the monitor.

7. A video communication apparatus comprising:
a receiver for receiving an opposite party's image captured according to a specific video period;
a monitor unit for displaying the received image according to a display period; and
a synchronization unit for synchronizing the video period of the received image and the display period of the monitor unit.

8. The video communication apparatus of claim 7, further comprising a camera unit for capturing an image of a user from a back side of the monitor unit, wherein the monitor unit repeats mode switching between a video mode and a transparent mode according to the display period.

9. The video communication apparatus of claim 8, the camera unit captures the image of the user only when the monitor unit is in the transparent mode.

10. The video communication apparatus of claim 7, wherein the monitor unit can use a screen by splitting the screen.

11. The video communication apparatus of claim 10, further comprising a camera for capturing an image of a user from a back side of a screen used for video communication among the split screens of the monitor unit.

12. The video communication apparatus of claim 11, wherein the camera unit captures the image of the user only when the monitor unit is in the transparent mode.

13. A video communication method comprising:
outputting received video communication data as a video image of a monitor;
capturing an image of a user from a back side of a screen of the monitor; and
transmitting the captured user's image to an opposite party of video communication as video communication data,
wherein the outputting of the video image and the capturing of the user's image are repetitively performed in parallel, and
wherein the monitor periodically repeats a video mode and a transparent mode.

14. The video communication method of claim 13, wherein the capturing of the user's image is performed only when the monitor is in the transparent mode.

15. The video communication method of claim 13, further comprising, if the received video communication data is streaming data for transmitting video data according to a specific period, synchronizing a video data period of the streaming data and a mode switching period of the monitor.

16. The video communication method of claim 13, wherein the camera is located at a center portion in a back side of the monitor.

17. The video communication method of claim 13, further comprising changing a position and/or an angle of a camera according to perspective movement of the user.
